(19) United States
(12) Patent Application Publication
(10) Pub. No.: US 2019/0098637 A1
(43) Pub. Date: Mar. 28, 2019

(54) IMPROVING COMMUNICATION QUALITY BETWEEN A WIRELESS COMMUNICATION NODE; AND WIRELESS COMMUNICATION DEVICES

(71) Applicant: Telefonaktiebolaget LM Ericsson (publ), Stockholm (SE)

(72) Inventors: Thomas CHAPMAN, Solna (SE); Torbjörn ELFSTRÖM, Fjärås (SE); Farshid GHASEMZADEH, Sollentuna (SE); Esther SIENKIEWICZ, Ottawa (CA)

(21) Appl. No.: 16/091,860

(22) PCT Filed: Apr. 22, 2016
(86) PCT No.: PCT/SE2016/050356

§ 371 Date: Oct. 5, 2018

(51) Int. Cl. H04W 72/08; H04W 72/04; H04L 5/00

(52) U.S. Cl. CPC H04W 72/082; H04W 72/048; H04L 5/0057; H04W 72/0453

(57) ABSTRACT

A wireless communication node operates using radio resources in a first frequency allocation with a first type of communication configuration and in a second frequency allocation with a second type of communication configuration. An operation control device determines a profile of the interference between transmissions in the two frequency allocations, the interference profile setting out radio resources in at least the first frequency allocation, deemed to be interfered by transmissions in the second frequency allocation, and provides the interference profile for adjusting communication between the wireless communication node and the wireless communication devices for improving communication quality in the first frequency allocation. A wireless communication device in turn adjusts communication settings for the first frequency allocation based on the interference profile.

### TECHNICAL FIELD

The invention relates to a wireless communication network having two different frequency allocations. More particularly, the invention relates to a method, operation control device, computer program and computer program product for improving communication quality between a wireless communication node in a wireless communication network and at least two wireless communication devices as well as to a method, wireless communication device, computer program and computer program product for assisting in improving communication quality.

### BACKGROUND

Wireless communication networks of today have to accommodate different types of traffic. They have to handle traffic to and from user devices, such as mobile phones, often denoted user equipment (UE), as well as different types of machine devices involved in machine-to-machine communication, for instance Internet-of-Things (IoT). All these types of traffic may have different requirements on the wireless communication network.

Furthermore, wireless communication networks such as the various types of mobile communication networks according to the Third Generation Partnership Project Radio Access Network (3GPP RAN) specifications are developed around the concept of carriers. A carrier is a range of frequencies within which a complete, decodable and standalone UMTS Terrestrial Radio Access (UTRA) or Enhanced UMTS Terrestrial Radio Access E-UTRA signal is transmitted, where UMTS is an acronym for Universal Mobile Telecommunications System. For UTRA, the bandwidth of a carrier is fixed at 5 MHz. For E-UTRA, a number of carrier bandwidths are enabled by the specification, with the maximum bandwidth being 20 MHz.

Many operators possess sufficient blocks of spectrum that they can operate more than one carrier. Operating more than one carrier directly increases the capacity of their deployment. Furthermore, in successive 3GPP releases UE capabilities have been extended such that UEs can simultaneously process multiple carriers, increasing the data rates available to such UEs.

For indoor networks, it might be the case that a common infrastructure is needed to provide services for multiple operators. If this is the case, then even if the individual operators do not operate consecutive carriers, then adjacent carriers belonging to different operators may be transmitted simultaneously from the same antennas.

To provide for the need to operate multiple carriers, today's Multi Standard Radio (MSR) and Long Term Evolution (LTE) base stations can transmit a number of carriers simultaneously. For each individual carrier, the transmitted signal comprises a wanted signal within the carrier bandwidth and unwanted emissions that arise from nonlinearities within the transmitters. The unwanted emissions generally reduce in power spectral density (PSD) with increasing frequency separation from the wanted carrier.

When simultaneous carriers are transmitted, the unwanted emissions from one carrier can cause interference on the next carrier.

This interference may become problematic if the distance between two such carriers, often denoted a guard band, is small.

There is therefore a need for improving the communication quality when there are transmissions on two different carriers.

### SUMMARY

One object is therefore to improve communication quality in a wireless communication network when there are transmissions on two different carriers.

This object according to a first aspect achieved through a method of improving communication quality between a wireless communication node in a wireless communication network and at least two wireless communication devices. The wireless communication node operates using radio resources in a first frequency allocation with a first type of communication configuration and in a second frequency allocation with a second type of communication configuration. The method is performed by an operation control device controlling the operation of the wireless communication node and comprises:

determining a profile of the interference between transmissions in the two frequency allocations, where the interference profile sets out radio resources in at least the first frequency allocation deemed to be interfered by transmissions in the second frequency allocation, and providing the interference profile for adjusting communication between the wireless communication node and the wireless communication devices for improving communication quality in the first frequency allocation.

The object is also achieved by an operation control device for improving communication quality between a wireless communication node in a wireless communication network and at least two wireless communication devices. The wireless communication node operates using radio resources in a first frequency allocation with a first type of communication configuration and in a second frequency allocation with a second type of communication configuration. The operation control device controls the operation of the wireless communication node and comprises a processor and a memory, where the memory contains instructions executable by the processor through which the operation control device is configured to: determine a profile of the interference between transmissions in the two frequency allocations, where the interference profile sets out radio resources in at least the first frequency allocation deemed to be interfered by transmissions in the second frequency allocation, and provide the interference profile for adjusting communication between the wireless communication node and the wireless communication devices for improving communication quality in the first frequency allocation.

The object is furthermore achieved by a computer program for improving communication quality between a wireless communication node in a wireless communication network and at least two wireless communication devices. The wireless communication node operates using radio resources in a first frequency allocation with a first type of communication configuration and in a second frequency allocation with a second type of communication configuration. The computer program comprises computer program code operative to cause an operation control device controlling the operation of the wireless communication node to, when the computer program code is loaded into the operation control device, determine a profile of the interference between transmissions in the two frequency allocations, where the interference profile sets out radio resources in at least the first frequency allocation deemed to be interfered by transmissions in the second frequency allocation, and provide the interference profile for adjusting communication between the wireless communication node and the wireless communication devices for improving communication quality in the first frequency allocation.

The object is also achieved by a computer program product for improving communication quality between a wireless communication node in a wireless communication network and at least two wireless communication devices. The computer program product comprises a data carrier with computer program code according to the third aspect.

In one variation of the first aspect, the providing of the interference profile for adjusting communication comprises instructing wireless communication devices communicating in the first frequency allocation to adjust channel quality determinations based on the interference profile

In a corresponding variation of the second aspect, the operation control device is operative to instruct wireless communication devices communicating in the first frequency allocation to adjust channel quality determination based on the interference profile when providing the interference profile.

In another variation of the first and second aspects, the applying of the interference profile comprises informing of the radio resources deemed to be interfered. In this case the instruction may be an instruction to provide two channel quality indications, one for interfered radio resources and one for non-interfered radio resources. Alternatively the instruction may be an instruction to exclude the interfered radio resources from the determining of channel quality indications. The instruction may additionally be an instruction to determine a difference in quality between the interfered radio resources and the non-interfered radio resources.

In a further variation of the first aspect, the providing of the interference profile for adjusting communication comprises using the interference profile to adjust operation in the first frequency allocation.

In a corresponding variation of the second aspect, the operation control device is configured to use the interference profile to adjust operation in the first frequency allocation when providing the interference profile for adjusting communication.

In yet another variation of the first aspect, the adjusting of operation comprises scheduling, in the first frequency allocation, wireless communication devices experiencing communication quality below a first communication quality threshold on radio resources experiencing interference and scheduling wireless communication devices experiencing communication quality above the first communication quality threshold on non-interfered radio resources.

In a corresponding variation of the second aspect, the operation control device is configured to schedule wireless communication devices experiencing communication quality below a first communication quality threshold on radio resources experiencing interference and schedule wireless communication devices experiencing communication quality above the first communication quality threshold on non-interfered radio resources in the first frequency allocation when providing the interference profile for adjusting communication.

In one variation of the first and second aspect, the adjusting of operation comprises increasing the robustness of the communication on the interfered radio resources in the first frequency allocation, where the increased robustness may be obtained through a change in coding and modulation. It is in this case furthermore possible that at least some of the wireless communication devices of the first frequency allocation are informed about the difference in robustness used among the different radio resources. The adjusting of operation may also comprise scheduling wireless communication devices experiencing communication quality above a second communication quality threshold on the interfered radio resources.

Another object is to assist in improving communication quality in a wireless communication network when there are transmissions on two different carriers.

This object is according to a fifth aspect achieved through a method of assisting in improving communication quality between a wireless communication node of a wireless communication network and at least two wireless communication devices. The wireless communication node operates using radio resources in a first frequency allocation with a first type of communication configuration and in a second frequency allocation with a second type of communication configuration. The method is performed by a wireless communication device communicating with the wireless communication node in the first frequency allocation and comprises:

adjusting communication settings for the first frequency allocation based on a profile of the interference between transmissions in the two frequency allocations, the interference profile setting out radio resources in at least the first frequency allocation deemed to be interfered by transmissions in the second frequency allocation.

The object is according to a sixth aspect achieved through a wireless communication device for assisting in improving communication quality between a wireless communication node of a wireless communication network and at least two wireless communication devices, the wireless communication node operating using radio resources in a first frequency allocation with a first type of communication configuration and in a second frequency allocation with a second type of communication configuration. The wireless communication device communicates with the wireless communication node in the first frequency allocation. It also comprises a processor and a memory, where the memory comprises instructions executable by the processor, through which the wireless communication device is configured to:

adjust communication settings for the first frequency allocation based on a profile of the interference between transmissions in the two frequency allocations, the interference profile setting out radio resources in at least the first frequency allocation deemed to be interfered by transmissions in the second frequency allocation.

The object is according to a seventh aspect achieved through a computer program for assisting in improving communication quality between a wireless communication node of a wireless communication network and at least two wireless communication devices. The wireless communication node operates using radio resources in a first frequency allocation with a first type of communication configuration and in a second frequency allocation with a second type of communication configuration. The computer program comprises computer program code operative to cause a wireless communication device communicating with the wireless communication node in the first frequency allocation to, when the computer program code is loaded into the wireless communication device: adjust communication settings for the first frequency allocation based on a profile of the interference between transmissions in the two frequency allocations, the interference profile setting out radio resources in at least the first frequency allocation deemed to be interfered by transmissions in the second frequency allocation.

The object is according to an eighth aspect achieved through a computer program product for assisting in improving communication quality between a wireless communication node of a wireless communication network and at least two wireless communication devices. The computer program product comprises a data carrier with computer program code according to the seventh aspect.

In one variation of the fifth aspect, the adjusting of communication settings comprises adjusting channel quality determinations for the first frequency allocation

In a corresponding variation of the sixth aspect, the wireless communication device is configured to adjust channel quality determinations for the first frequency allocation when adjusting communication settings.

In other variations of the fifth aspect, the adjusting of channel quality determinations may comprise performing two channel quality determinations, one for the non-interfered radio resources and another for the interfered radio resources. Alternaitvely it may comprise excluding the interfered radio resources from the determining of channel quality indications. It may additionally comprise determining a difference in quality between the interfered radio resources and the non-interfered radio resources.

In corresponding variations of the sixth aspect, the wireless communication device is configured to perform two channel quality determinations, one for the non-interfered radio resources and another for the interfered radio resources when adjusting channel quality determinations. Alternatively it may be configured to exclude the interfered radio resources from the determining of channel quality indications. It may additionally be configured to determine a difference in quality between the interfered radio resources and the non-interfered radio resources.

The channel quality determinations may furthermore be reported to the wireless communication node.

In a further variation of the fifth aspect, the adjusting of communication settings comprises communicating on radio resources experiencing interference in case an own communication quality is below a first communication quality threshold and otherwise on non-interfered radio resources.

In a corresponding variation of the sixth aspect, the wireless communication device is configured to communicate on radio resources experiencing interference in case an own communication quality is below a first communication quality threshold and otherwise on non-interfered radio resources when adjusting communication settings.

In yet another variation of the fifth aspect, the adjusting of communication settings comprises increasing the robustness of the communication in case it is carried out on radio resources experiencing interference. The increased robustness may be obtained through a change in coding and modulation. The change in coding and modulation may furthermore be made based on information about a coding and modulation difference received from the wireless communication network.

In a corresponding variation of the sixth aspect, the wireless communication device, when adjusting communication settings, is configured to increase the robustness of the communication in case it is carried out on radio resources experiencing interference. The increased robustness may be obtained through a change in coding and modulation. Furthermore, when obtaining a change in coding and modulation, the wireless communication device may be configured to make a change in coding and modulation based on information about a coding and modulation difference received from the wireless communication network.

In yet a further variation, the radio resources experiencing interference may be used in case an own communication quality is above a second communication quality threshold.

The invention has a number of advantages. It improves communication quality. This is furthermore done without the need of a large guard band and extensive filtering. Thereby it is possible to have an improved spectral efficiency and a simpler filter realization.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a cloud computing device connected to an access network of a wireless communication network via a core network of the same wireless communication network, where the access network comprises base stations,

FIG. 2 schematically shows a first base station in the access network communication with a first and a second group of wireless communication devices,

FIG. 3 shows a block schematic of the first base station,

FIG. 4 shows a block schematic of a first realization of a communication control device controlling the operation of the first base station,

FIG. 5 shows a block schematic of a second realization of the communication control device,

FIG. 6 shows a block schematic of a first realization of a wireless communication device that assists the operation control device,

FIG. 7 shows a block schematic of a second realization of the wireless communication device,

FIG. 8 shows a graph of the power and frequency used in two neighbouring frequency allocations with two different numerologies,

FIG. 9 schematically shows a part of the graph in FIG. 8 where interference from the numerology of one of the frequency allocations creates interference in some radio resources of the numerology used in the other frequency allocation,

FIG. 10 shows a flow chart of a number of steps being performed by the operation control device in a first embodiment of a method for improving communication quality between the first base station and wireless communication devices,

FIG. 11 shows a step being performed by the wireless communication device in a first embodiment of a method for assisting in improving communication quality,

FIG. 12 shows a flow chart of a number of steps being performed by the operation control device in a second embodiment of the method of improving communication quality between the first base station and wireless communication devices,

FIG. 13 shows a flow chart of a number of steps being performed by the operation control device in a third embodiment of the method of improving communication quality between the first base station and wireless communication devices,

FIG. 14 shows a flow chart of steps being performed by the wireless communication device in a second embodiment of a method for assisting in improving communication quality,

FIG. 15 shows a flow chart of steps being performed by the wireless communication device in a third embodiment of a method for assisting in improving communication quality,

FIG. 16 shows a computer program product comprising a data carrier with computer program code for implementing functionality of the operation control device, and

FIG. 17 shows a computer program product comprising a data carrier with computer program code for implementing functionality of the wireless communication device.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail.

The present invention concerns the improving of communication quality between a wireless communication node in a wireless communication network and at least two wireless communication devices.

The wireless communication network may as an example be a mobile communication network like a Long-Term Evolution (LTE), Universal Mobile Telecommunications System (UMTS) or Nx or NR or 5G network. The invention will be described below in relation to LTE or Nx or NR. These are just a few examples of networks where the invention may be used. Countless others are contemplated.

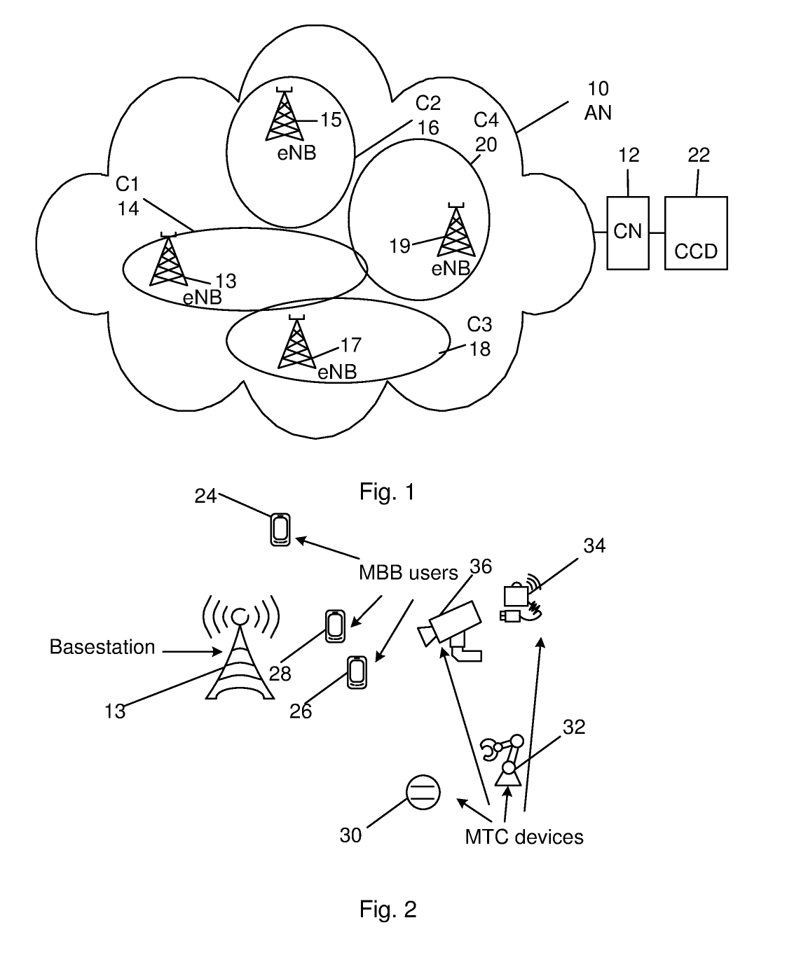

FIG. 1 schematically shows a wireless communication network which may be a network according to any of the above described types. The network may furthermore comprise an access network AN 10 and a core network CN 12, where the access network 10 comprises a first base station 13 providing coverage of a first cell C1 14, a second base station 15 providing coverage of a second cell C2 16, a third base station 17 providing coverage of a third cell C3 18 and a fourth base station 19 providing coverage of a fourth cell C4 20. It should here be realized that a base station may provide more than one cell. A base station is often termed NodeB or eNodeB.

In FIG. 1 there is also shown a cloud computing device CCD 22. The cloud computing device 22 is an example of one realization of an operation control device for a wireless communication node in the wireless communication network, where a base station is an example of such a wireless communication node.

FIG. 2 shows a number of wireless communication devices communicating wirelessly with the first base station 13. The wireless communication devices are not nodes in the wireless communication system but instead devices that access the wireless communication network via the access network 10. The wireless communication devices are furthermore provided in at least two groups. There is a first group of wireless communication devices, where the wireless communication devices in the first group are mobile broadband (MBB) devices, typically in the form of user devices such as mobile terminals like a smart phones or computers, like laptop or palmtop computers. Such a wireless user device is also often termed a user equipment (UE). In the figure there is a first, second and third MBB device 24, 26 and 28.

The wireless communication devices in the second group are on the other hand Machine Communication Terminals (MTC), such as sensors, robots and surveillance equipment. In the figure there is a first, second third and fourth MTC device 30, 32, 34 and 36. The MTCs are examples of machine devices involved in machine-to-machine communication, for instance in Internet-of-Things (IoT) operation.

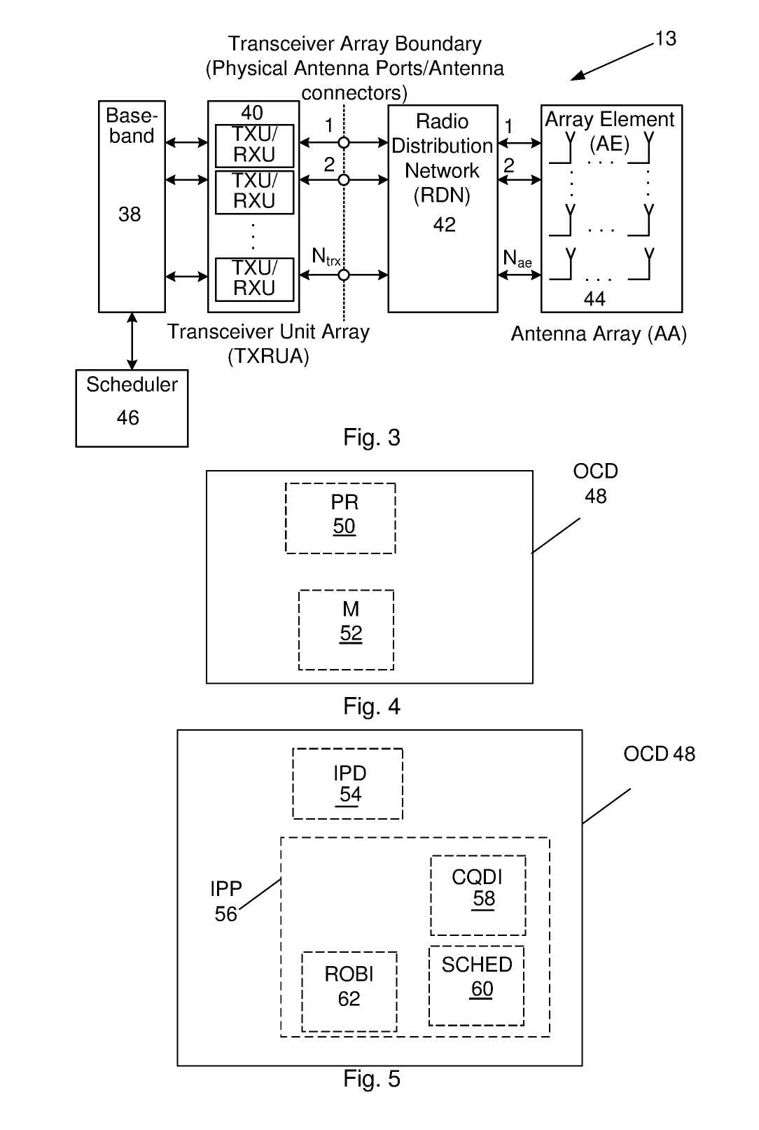

FIG. 3 shows a block schematic of one way of realizing a base station, such as the first base station 13. In the first base station 13 there is a baseband block 38 connected to a transceiver unit array block (TXRUA) 40 comprising a number of transmitting/receiving units or transceiver units TXU/RXU. The transceiver unit array block 40 is in turn connected to a radio distribution network block (RDN) 42 via a transceiver array boundary comprising a number of physical antenna ports and antenna connectors. The RDN block 42 is in turn connected to an antenna array block AA 44 comprising a number of antenna elements. There is finally a scheduler block 46 connected to the baseband block 38 for scheduling communication on one or more carriers. The scheduler block 46 is another example of an operation control device for a wireless communication node of the wireless communication network, where the wireless communication node in this case is the first base station 13.

FIG. 4 shows a block schematic of a first way of realizing the operation control device OCD 48. It may be provided in the form of a processor PR 50 connected to a program memory M 52. The program memory 52 may comprise a number of computer instructions implementing the functionality of the operation control device 48 and the processor 50 implements this functionality when acting on these instructions. It can thus be seen that the combination of processor 50 and memory 52 provides the operation control device 48.

FIG. 5 shows a block schematic of a second way of realizing the operation control device 48. The operation control device 48 may comprise an interference profile determining unit IPD 54 and an interference profile providing unit IPP 56. Furthermore, the interference profile providing unit 56 in turn comprises a communication quality determination instructing element CQDI 58, a scheduling element SCHED 60 and a robustness improving element ROBI 62.

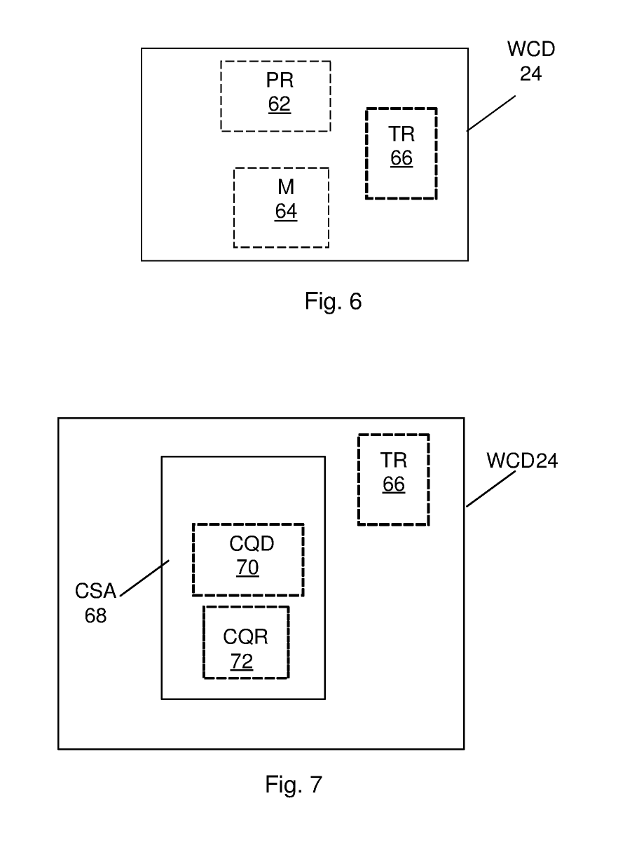

FIG. 6 shows a block schematic of a first way of realizing a wireless communication device WCD 24, for instance the first user device in the first group of wireless communication devices. It may be provided in the form of a processor PR 62 and program memory M 64 together with a transceiver unit TR 66. The transceiver unit 66 is also connected to an antenna (not shown). The program memory 52 may comprise a number of computer instructions implementing functionality that is used to assist the improvement or enhancing of communication quality in the wireless communication network and the processor 62 implements this functionality when acting on these instructions. It can thus be seen that the combination of processor 62 and memory 6 4 provides the communication quality enhancing assisting functionality of the wireless communication device 24.

FIG. 7 shows a block schematic of a second way of realizing the wireless communication device 24. It comprises the transceiver unit TR 66 and a communication setting adjusting unit CSA 68. The communication setting adjusting unit 68 furthermore comprises a communication quality determining element CQD 70 and a communication quality reporting element CQR 72.

The units and elements in FIGS. 5 and 7 may be provided as software blocks, for instance as software blocks in a program memory, but also as a part of dedicated special purpose circuits, such as Application Specific Integrated Circuits (ASICs) and Field-Programmable Gate Arrays (FPGAs). It is also possible to combine more than one element or unit in such a circuit.

As can be seen in FIGS. 1 and 2 there may be a need to accommodate a number of different wireless communication devices, which may also have different requirements on the wireless communication network. Therefore different communication configurations may be used in the wireless communication network for different types of wireless communication devices. However, when different communication configurations are used it is likely that interference in the system will increase. It is likely that system adaptions made for the different types of devices may lead to increased interference, especially if the radio resources, such as frequencies, are limited. This situation will now be expanded on somewhat.

In many wireless communication networks, such as LTE an NX, the communication structure used is divided into carriers, where each carrier is transmitted in a certain frequency allocation and has a number of subcarriers separated by a common spacing or step size, such as 7.5 Hz and 15 kHz, where a frequency allocation may be a frequency range allocated to a carrier. The subcarrier spacing is an example of one type of network communication configuration, which is a system structure configuration that can be influenced in order to meet the demands of different types of wireless communication devices. Another communication configuration that can be influenced is a transmission configuration such as output or transmission power or power spectral density.

Many operators possess sufficient blocks of spectrum so that they can operate more than one carrier. Operating more than one carrier directly increases the capacity of their deployment. Furthermore, in successive Third Generation Partnership Project (3GPP) releases UE capabilities have been extended such that UEs can simultaneously process multiple carriers, increasing the data rates available to such UEs.

For indoor networks, it might be the case that a common infrastructure is needed to provide services for multiple operators. If this is the case, then even if the individual operators do not operate consecutive carriers, then adjacent carriers belonging to different operators may be transmitted simultaneously from the same antennas.

To provide for the need to operate multiple carriers, today's Multi Standard Radio (MSR) and Long Term Evolution (LTE) base stations can transmit a number of carriers simultaneously. For each individual carrier, the transmitted signal comprises a wanted signal within the carrier bandwidth and unwanted emissions that arise from nonlinearities within the transmitters. The unwanted emissions generally reduce in power spectral density (PSD) with increasing frequency separation from the wanted carrier.

When simultaneous carriers are transmitted, the unwanted emissions from one carrier can cause interference on the next carrier.

In order to mitigate the impact of interference between carriers, the carriers are not placed as close together as theoretically possible in frequency. Instead, a so-called “guard band” is introduced between the carriers. Nothing is intentionally transmitted within the guard band. Since the unwanted emissions decrease with increasing frequency separation between carriers, increasing the frequency separation in this manner reduces interference between carriers.

Introducing guard bands however leads to portions of the available spectrum being unused. For maximizing spectral efficiency, it is important that the guard bands are kept as small as possible. On the other hand, smaller guard bands increase significantly the complexity of filtering required to avoid unwanted emissions from one carrier spilling over to the next.

A so-called numerology is a set of Orthogonal Frequency Division Multiplexing (OFDM) parameters defined for an LTE or NX signal, such as carrier spacing, cyclic prefix length etc. For LTE, there are two numerologies with either 15 or 7.5 kHz subcarrier spacing, although the 15 kHz is commonly used. A numerology is an example of a communication configuration of a wireless communication network.

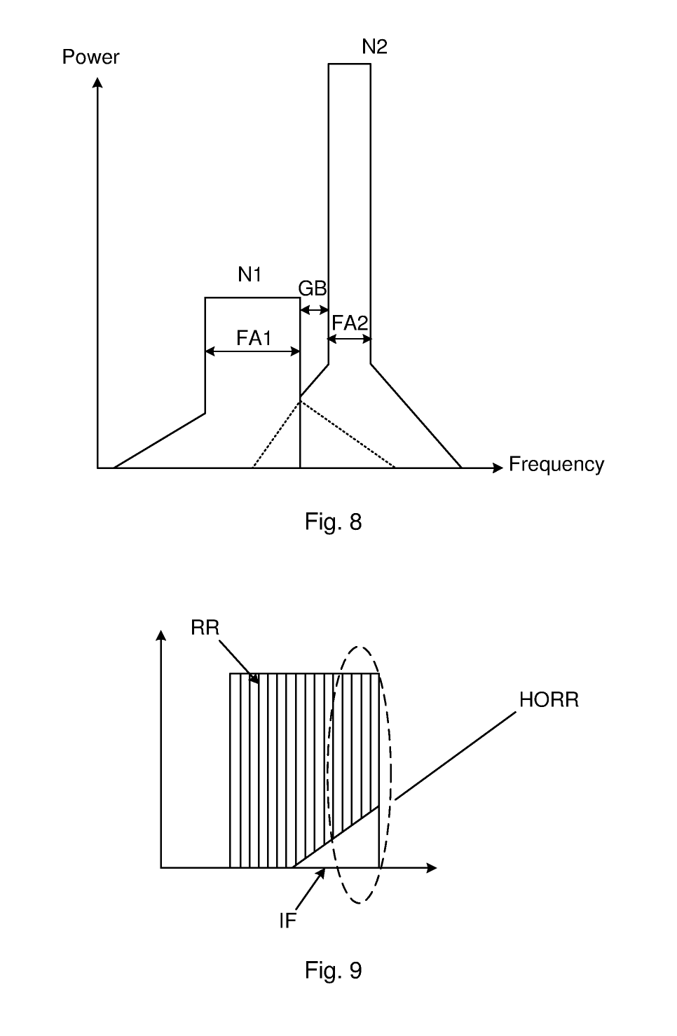

Within 5G timescales, 3GPP will need to support a much wider range of frequencies, latency and Quality of Service (QoS) demands and services. To provide such wide-ranging support, several numerologies may need to be standardized. Furthermore, it is envisaged that in some circumstances, different numerologies may need to be transmitted within the same spectrum and from the same transmitter, potentially with different power spectral density. One such example is a scenario in which both Mobile Broadband (MBB) and Machine Type Communication (MTC) are supported. For achieving high coverage at low data rates, MTC is transmitted with a high PSD, low bandwidth and long time duration. This requires a low subcarrier spacing. At the same time, for achieving latency requirements MBB services must be transmitted over a shorter period of time, which implies a larger subcarrier spacing. An example of this is shown in FIG. 8, where there is a first frequency allocation FA1 for a first carrier where a first numerology N1 is used and a second frequency allocation FA2 for a second carrier where a second numerology N2 is used. Each frequency allocation thereby covers a range of frequencies allocated to a certain carrier. The two frequency allocations are furthermore separated by a Guard band GB. In this example the first frequency allocation FA1 is used for the first type of wireless communication devices, the user devices, and MBB services, while the second frequency allocation FA2 is used for the second type of wireless communication devices, the machine devices, and MTC services. In this example the frequencies in the first frequency allocation are lower than the frequencies of the second frequency allocation.

In order to accommodate both types of service, the frequency block over which NX is transmitted may be transmitted in two portions, i.e. in the two frequency allocations FA1 and FA2. As can also be seen in FIG. 8 the transmission power or power spectral density PSD used in the second frequency allocation FA2 is higher, and here significantly higher than in the first frequency allocation FA1. Furthermore, the MBB services use a first numerology N1, while the MTC services use a second numerology N2, where the subcarrier spacing in the second numerology N2 is lower than the subcarrier spacing in the first numerology N1.

Similarly to an LTE multi-carrier case, when two numerologies are transmitted with different subcarrier spacing there will be interference between the numerologies. This is particularly true for the numerology with the lower PSD and larger subcarrier spacing. This is in FIG. 8 indicated through the low power levels of the transmissions in the frequency allocations spreading out on both sides of the range. It can more particularly be seen that the guard band GB is crossed by unwanted emissions.

FIG. 9 shows the radio resources RR of the first frequency allocation FA1, which resources are typically so-called resource blocks RBs. FIG. 9 more particularly shows interference IF in the form of the radio emissions from the transmissions in the second frequency allocation made on the higher subcarrier frequencies of the first frequency allocation. It can here be seen that highest order radio resources HORR are affected. The radio resources RR being affected by the emissions are thus the radio resources that are closest to the frequency range limit of the own frequency allocation facing the frequency range of the frequency allocation of the other type of transmission.

It should here be realized that the transmissions made in the first frequency allocation in a similar way causes emissions that interfere with subcarriers in the second frequency allocation. However, in this case the subcarriers being interfered are the low order radio resources, which are also the radio resources that are closest to the frequency range limit of the own frequency allocation facing the frequency range of the frequency allocation of the other type of transmission.

As was mentioned above, the traditional way of mitigating inter-carrier interference is to use a guard band to separate carriers and filtering to reduce the unwanted emissions. A guard band has the penalty of reducing spectral efficiency, whilst filtering implies complexity and cost.

The use of a guard band means that some of the frequencies are not used. This is a waste of radio resources, which are limited. It is therefore of interest to make such a guard band as small as possible or even to eliminate it.

For transmitting multiple numerologies for NX, similar solutions will be required for managing interference between the numerologies. The amount of filtering required for avoiding the need for a guard band between numerologies would be prohibitively complex and costly. On the other hand, introduction of an in-block guard band would reduce spectral efficiency and may be unacceptable to operators.

In some circumstances, the guard bands are kept small between LTE carrier or between numerologies despite the filtering not being sufficient to minimize interference between the numerologies/carriers. The reduced guard bands increase the amount of increased frequency resources, however the spectral efficiency is compromised by the interference, e.g. caused by unwanted emissions, that leaks between carriers in these cases.

The invention is addressing one or more of these problems.

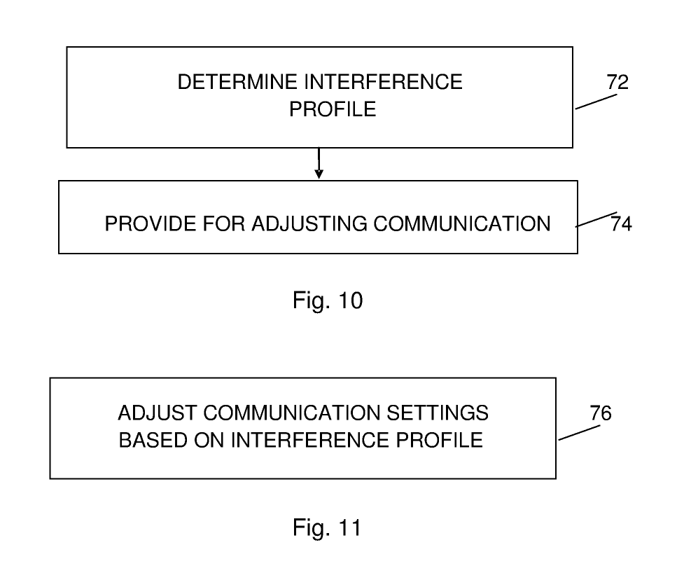

A first embodiment will now be described with reference being made also to FIG. 10, which shows a flow chart of method steps being performed by the operation control device 48 in a method of improving communication quality in the wireless communication network, and to FIG. 11, which shows a method step being performed by a wireless communication device in a method of assisting in improving communication quality in the wireless communication network.

Furthermore, in this embodiment it is assumed that the scheduling block 46 of the base station is also the operation control device 48, even though, as was mentioned earlier, the operation control device 48 may be provided through the cloud computing device CCD 22 or through a separate base station control device in the wireless communication network.

Furthermore, the scheduler block 46 of the first base station 13 may schedule transmissions with a number of wireless communication devices. It may for instance schedule the first, second and third user terminals 24, 26 and 28 for operation in the frequency range of the first frequency allocation FA1, where each may be scheduled to receive transmissions from the first base station 13 on one or more subcarriers in the first frequency allocation FA1. In a similar manner the scheduler 46 may schedule the first, second, third and fourth machine devices 30, 32, 34 and 36 for operation in the frequency range of the second frequency allocation FA2, where each may be scheduled to receive transmissions from the first base station 13 on one or more subcarriers in the second frequency allocation FA2. The scheduler block 46 is responsible for assigning resources to user devices and machine devices and allocating appropriate modulation and coding rates. The transmissions in the first frequency allocation FA1 are furthermore made with the first numerology N1 and the transmissions in the second frequency allocation with the second numerology N2, where, as was mentioned earlier, the subcarrier spacing is higher in the first numerology N1 than in the second numerology N2. The power spectral density is also higher in the second frequency allocation FA2 than in the first frequency allocation FA1.

Thereby there are transmissions in both frequency allocations and as the guard band GB is small there is consequently a risk for emissions from one frequency allocation interfering subcarriers in the other frequency allocation. It is for instance possible that the transmissions made to the machine devices 30, 32, 34 and 36 in the second frequency allocation FA2 interfere the upper subcarriers or high order radio resources HORR of the first frequency allocation FA1 due to the high power spectral density being used.

The interference profile determining unit 54 of the operation control device 48 therefore determines a profile of the interference between transmissions in the two frequency allocations, step 72, where the interference profile sets out radio resources HORR such as resource blocks or subcarriers in at least the first frequency allocation FA1 deemed to be interfered by transmissions in the second frequency band FA2. These radio resources are thereby also deemed unreliable because of the unwanted emissions from the transmissions in the second frequency allocation FA2. Optionally or instead, it is possible that the profile sets out radio resources, such as subcarriers or resource blocks, in the second frequency allocation deemed to be interfered by transmissions in the first frequency allocation FA1. These radio resources are thereby also deemed unreliable because of the unwanted emissions from the transmissions in the first frequency allocation FA1. A radio resource deemed to be interfered or unreliable may be a radio resource experiencing undesired emissions above a certain unwanted emission threshold level.

There are a number of ways in which an interference profile may be obtained. The interference level is often dependent on the design of the radio frequency parts of the base station and this may therefore be known to the base station designer. The power spectrum density, schedule subcarrier and calculations of known variations, such as sin α/α, may also be made for determining affected subcarriers. It is also possible that the filter response of a transmission filter connected between the block 40 and antenna array 44 can be used for determining which radio resources in the first and/or the second frequency allocation are interfered by transmission in the other, i.e. experiencing unwanted emissions above an undesired emission threshold level.

The interference profile may then comprise an indication of the affected subcarriers in each frequency allocation. Alternatively the interference profile may comprise an indication of the frequency range in which the affected subcarriers are provided. As yet another alternative there may be one frequency profile per frequency allocation.

Thereafter the interference profile providing unit 56 provides the interference profile for adjusting communication between the wireless communication node 13 and the wireless communication devices in order to improve communication quality in the first frequency allocation FA1, step 74. If only the first frequency allocation FA1 is to be acted upon then the profile may be provided for improving communication quality of the communication in the range of the allocation. If also the second frequency allocation is to be acted upon also the communication in this allocation may be improved using the same or a separate interference profile.

There are a number of ways in which the interference profile may be used for improving communication. The interference profile may be used for adjusting operation in the first frequency allocation FA1. The interference profile may for instance be used by the scheduling element 60 for scheduling communication in the first frequency allocation FA1. If there is more than one user terminal communicating in the first frequency allocation FA1 then it is possible that the one experiencing low communication quality is scheduled to interfered resources or resources affected by the emissions, while the devices experiencing high communication qualities may be scheduled in non-interfered resources or subcarriers where there are negligible unwanted emissions from the second frequency allocation FA2. As an alternative it is possible that a wireless communication device experiencing a good communication quality is scheduled anywhere in the frequency allocation, for instance in the subcarriers that do experience unwanted emissions from the second frequency allocation FA2. In the latter case it is possible that the robustness improving element 62 uses the interference profile in order to improve the robustness of the communication in the first frequency allocation FA1 for transmissions having good communication quality, for instance through adjusting channel coding and modulation. The interference profile may also be used by one or more of the wireless communication devices in order for them to change the way that channel quality determinations, such as Channel Quality Indication (CQI) determinations, are being made in order to take account of the fact that some subcarriers experience unwanted emissions and are therefore unreliable. If this is not done then a channel quality indication may be provided that does not properly reflect the channel quality of a resource that is to be used between the wireless communication node and the wireless communication device. This may for instance lead to the wrong power levels being used, which may lead to a waste of energy and unnecessary high coding complexity or to a loss of signal.

One or more of the wireless communication devices in the first frequency allocation FA1 may then adjust communication settings based on the interference profile, step 76. For this reason a wireless communication device, for instance the first user terminal 24, may receive the interference profile, for instance as information of a frequency range in which there is deemed to be interference or as information about the actual subcarriers that are deemed to be interfered according to the interference profile. This may then be used by the communication quality determining element 70 to adjust channel quality determinations CQIs that are determined using the transceiver 66. It is for instance possible that two different channel quality determinations are being made for the first frequency allocation FA1, one for the non-interfered radio resources, i.e. subcarriers deemed reliable because they experience little or negligible emissions from the second frequency allocation FA2, and one for the interfered radio resources, i.e. subcarriers deemed unreliable because they experience interference from the second frequency allocation FA2. Alternatively it is possible that the radio resources identified in the profile are excluded from the channel quality determinations. Another way in which the wireless communication device may be involved in the changing of communication settings is through determining an own communication quality, such as a signal-to-noise value, and either provide to the first base station 13 for determining scheduling and/or robustness improvement or itself determining if the own communication quality is such that the first base station 13 should schedule communication on a non-interfered or an interfered resource and possibly with robustness improvement.

Through the various ways that communication quality is improved a number of varying advantages are achieved. It improves the communication quality without a large guard band and extensive filtering. Thereby it is possible to have an improved spectral efficiency and a simpler filter realization. The use of modified CQIs provides a better reflection of the communication channel quality, which also improves the communication.

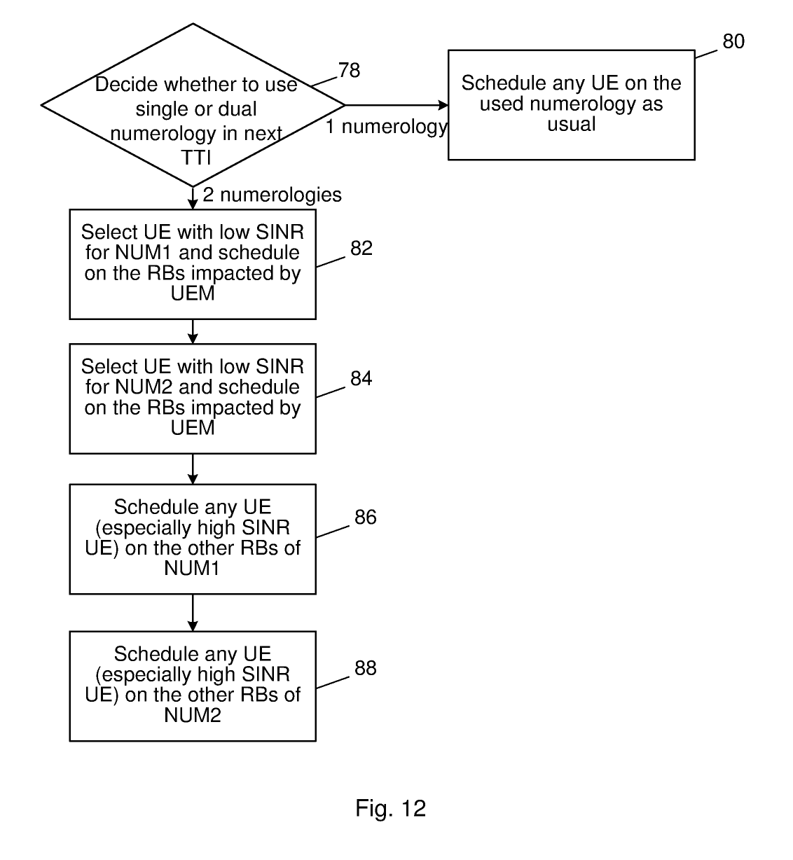

Now a second embodiment of the method of improving communication quality will be described with reference being made to FIG. 12, which shows a flow chart of a number of method steps being performed by the first base station 13.

In this case the communication quality determining elements 70 of all the various wireless communication devices determine communication quality, for instance as a signal to Interference and Noise Ratio (SINR) that is to be compared with a first communication quality threshold. This threshold may be a threshold used in order to indicate if the communication quality is high or low and more particularly if the communication quality experienced by the wireless communication device is so low that the additional interference caused by transmissions in the other frequency allocation has negligible effect. For this reason it can be seen that the first communication quality threshold differs between the two frequency allocations. There may thus be a first mobile broadband threshold and a first machine type communication threshold. In one variation the communication quality determining element 70 may be set to also perform the comparison with the first communication quality threshold and report the result to the first base station 13 via the transceiver 66. In another variation it may submit the communication quality determinations to the first base station 13 in order for the operation control device 48 to make the comparison, which comparison may then be made in the communication quality determination instructing element 58.

Furthermore, the interference profile determining unit 54 has also determined the interference profile for both the first and the second frequency allocation, which may have been done according to any of the ways described in the first embodiment.

In order to use the interference profile for improving communication quality between the wireless communication node and the user devices, the scheduler element 60 of the operation control device 48 may, for a given transmission time interval (TTI), investigate if there is communication to be performed in both numerologies or not. If communication is only to be made in one numerology, step 78, such as if only user devices are to communicate or only machine devices, then the scheduling element 60 schedules the communication in the numerology according to routine procedures, step 80. When the scheduling element 60 decides to transmit data on a single numerology only, then one or more wireless communication devices are scheduled for transmission on that numerology in the usual manner, considering also aspects such as data buffer size, Quality of Service (QoS) constraints, channel state information (CSI) reports etc.

However, if there are mobile communication devices that are to communicate in both frequency allocations, step 78, then the scheduling element 60 determines which wireless communication devices are to be scheduled on interfered radio resources and non-interfered radio resources in the two frequency allocations.

The scheduling element 60 may more particularly be adapted such that when scheduling data on the first numerology N1 it is aware of the scheduling on the second numerology N2 and vice versa, and also aware of the amount of interference that each numerology creates towards the other numerology through the interference profile. Furthermore, the scheduling element 60 is adapted such that it has information on which radio resources, such as on which RBs, of the first numerology N1 are significantly degraded when the second numerology N2 is scheduled, and which RBs on the second numerology N2 are significantly degraded when the first numerology N1 is scheduled.

If the scheduling element 60 decides to transmit on both numerologies, then it takes into account that some RBs that are close to the other numerology have a higher level of unwanted emissions than other RBs. For these RBs, which in the first frequency allocation are the high order radio resources HORR, a wireless communication device is scheduled that is experiencing a relatively low SINR. This means that in the first frequency allocation FA1, the scheduling element 60 selects and schedules user devices having a communication quality below the first MBB communication quality threshold on the unreliable radio resources, step 82, i.e. on the subcarriers with the unwanted emissions, and selects and schedules machine devices having a communication quality below the first MTC communication quality threshold on the unreliable radio resources, step 84. Furthermore, in the first frequency allocation FA1, the scheduling element 60 selects and schedules user devices having a communication quality above the first MBB communication quality threshold on the resources deemed to be non-interfered or reliable, step 86, and selects and schedules machine devices having a communication quality above the first MTC communication quality threshold on the resources deemed to be non-interfered or reliable, step 88.

Since a wireless communication device having a low SINR below the first communication quality threshold already experiences a lot of interference, the impact of the increased amount of Unwanted Emissions (UEM) will not be significant. For the reliable RBs, another wireless communication device is scheduled that may have high SINR above the first communication quality threshold. However, in this case it is also possible that a wireless communication device having SINR below the first communication quality threshold may be scheduled in this part of the frequency allocation.

This type of operation may then be repeated for a following TTI. The above desired embodiment has the same advantages as the first embodiment. Additionally existing communication structures and messages may be used.

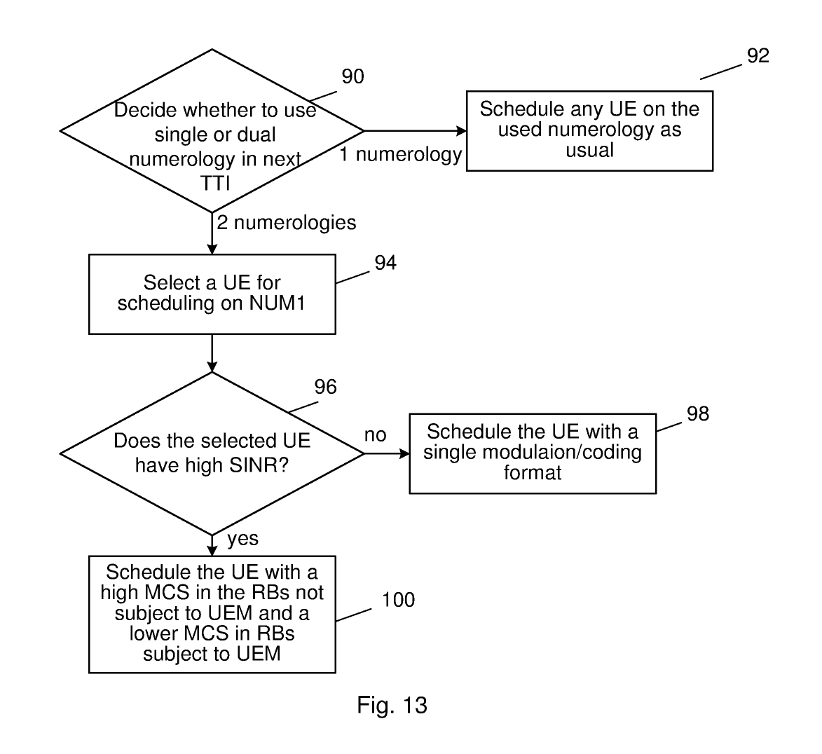

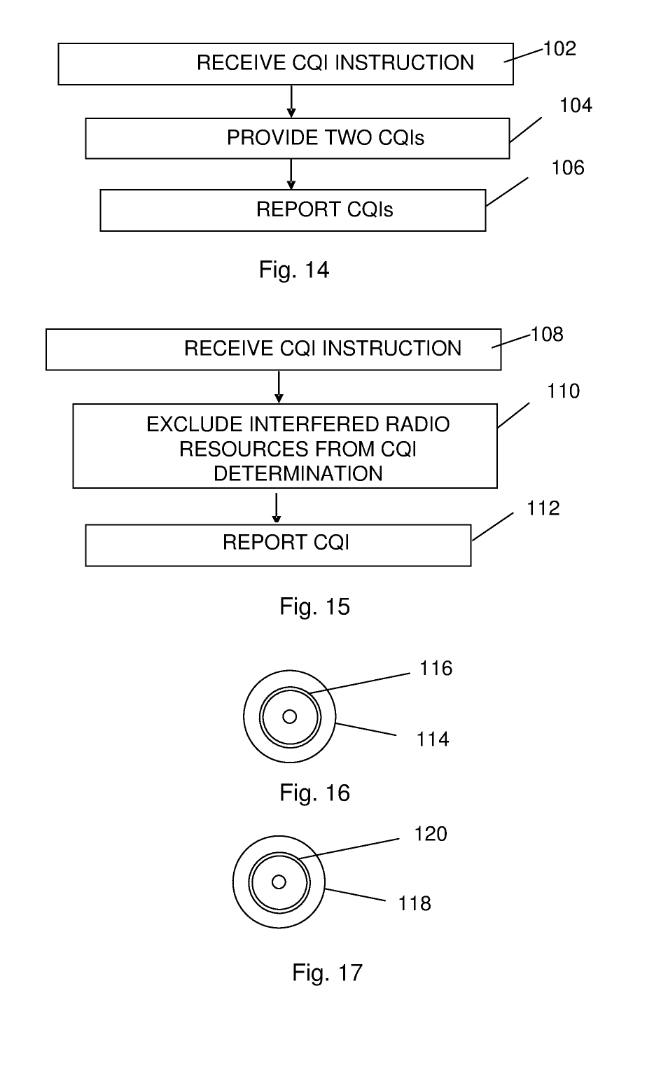

Now a third embodiment of the method of improving communication quality will be described with reference being made to FIG. 13, which shows a flow chart of a number of method steps being performed by the first base station 13.

Also in this case the communication quality determining elements 70 of all the various wireless communication devices determine communication quality, for instance as Signal to Interference and Noise ratio (SINR) that is to be compared with a second communication quality threshold. This threshold may be a threshold used in order to indicate if the communication quality is high. As the interference may differ in the two frequency bands the second communication quality threshold differs between the two frequency bands. Therefore there may be a second MBB communication quality threshold and a second MTC communication quality threshold. In one variation the communication quality determining element 70 may be set to also perform the comparison with the threshold and report the result to the first base station 13 via the transceiver 66. In another variation it submits the communication quality determinations to the first base station 13 in order for the operation control device 48 to make the comparison.

Furthermore, also here the interference profile determining unit 54 has determined the interference profile for both the first and the second frequency allocation according to the previously described principles.

The scheduling element 60 of the operation control device 48 may, for a given transmission time interval (TTI) investigate if there is communication to be performed in both numerologies or not. If communication is only to be made in one numerology, step 90, such as if only user devices are to communicate, then the scheduling element 60 schedules the communication in the numerology according to routine procedures, step 92. When the scheduling element 60 decides to transmit data on a single numerology only, then one or more wireless communication devices are scheduled for transmission on that numerology in the usual manner, considering aspects such as data buffer size, Quality of Service (QoS) constraints, channel state information (CSI) reports etc.

However, if there are mobile communication devices that are to communicate in both frequency allocations, step 90, then the scheduling element 60 determines which wireless communication devices are to be scheduled on unreliable or interfered radio resources and which are to be scheduled on reliable or non-interfered radio resources in the first frequency allocation.

The scheduling element 60 may more particularly be adapted such that when scheduling data on the first numerology N1 it is aware of the scheduling on the second numerology N2, and also aware of the amount of interference that each numerology creates towards the other numerology through the use of the interference profile. Furthermore, the scheduling element 60 is adapted such that through the interference profile it has information of which radio resources, such as which resource blocks (RBs) of the first numerology N1, are significantly degraded when the second numerology N2 is scheduled.

The scheduling element 60 more particularly selects one wireless communication device for scheduling in the first numerology N1, step 94. The selected device may as an example be the first user device 24.

This may then be scheduled in either the non-interfered radio resources or on interfered-resources. A resource may thus be scheduled in a conventional way.

Furthermore, also the communication quality of the user device is investigated. In this case the investigation is performed by the robustness improving element 62. It thus investigates the relationship between the communication quality of this wireless communication device and the corresponding second communication quality threshold.

The robustness improving element 62 thus compares the communication quality of the wireless communication device with the second communication quality threshold and if it is below the threshold, step 96, then no robustness improvement is performed. In this case an ordinary or conventional robustness is used irrespective of in which part of the frequency allocation the user terminal is scheduled by the scheduling element 60, step 98. However, in case the communication quality is above the second communication threshold, step 96, then the robustness of the user device is improved if an unreliable or interfered resource, i.e. a high order radio resource HORR, was selected but not if a reliable or non-interfered radio resource was selected. An improvement of the robustness may involve scheduling the user device with high Modulation and Coding Scheme (MCS) in the resource blocks that are not subject to UEM and a lower MCS in resource blocks subject to UEM, step 100.

Thereby the ability of the user device to handle the interference caused by the additional unwanted emissions is improved.

In the third embodiment, a single wireless communication device is scheduled in each numerology. However if the wireless communication device has high SINR, then for the RBs impacted by unwanted emissions from the other numerology, a more robust transmission is used (e.g. repetition, or a lower modulation order). This may for instance involve going from 256QAM modulation to 16QAM modulation.

The scheduled wireless communication devices may in this third embodiment need to be aware of the type of modulation and coding used for all of the RBs. This could be signalled to the wireless communication device in one of a number of ways:
The sets of RBs with more and less protection could be indicated to the user device via higher layer signalling prior to scheduling. Also, potentially an indication could be provided via scheduling of the difference between modulation & coding that is applied to each of the two blocks.
A simple indicator could be sent to the user device at the time of scheduling the number of consecutive RBs with more protection (the user device would then assume that the remainder have less protection). The modulation/coding difference could also be signalled at the time of scheduling, or could be signalled in advance via higher layer signalling.
The modulation and coding of the RBs could be explicitly signalled by the scheduling message.

It should be noted that for wireless communication devices with low SINR, it may not be necessary to differentiate between the RBs, since the unwanted emissions from the other numerology will anyhow not dominate.

The activities described above for the first frequency allocation FA1 may in an analogous manner be performed for the second frequency allocation.

A common aspect of both the second and third embodiments is that there is an adaptation to a node B scheduling algorithm such that if unwanted emissions are likely to occur on one of the carriers or numerologies that the node B is transmitting from one of the other carriers or numerologies, the scheduling element takes into account that high SINR may be compromised by unwanted emissions in a few of the resource blocks and adjusts the coding and modulation appropriately.

Both the second and third embodiments described above are also applicable for same numerologies where carrier spacing conditions to maintain orthogonality spectrum cannot be maintained due to various reasons e.g. size of available. This also indicates that for LTE Carrier Aggregation (CA), the principles described above can be applied.

Now a second embodiment of the method of assisting in improving communication quality performed by a wireless communication device will be given with reference being made to FIG. 15, where the wireless communication device may be the first user device.

In this embodiment the communication quality determining element 70 uses the interference profile that was determined by the operation control device 48. The use may be based on receiving an instruction concerning the way communication quality indications (CQI) are to be provided. Such an instruction may be sent by the communication quality determination instructing element 58 of the operation control device 48, step 102. In this embodiment the instruction is an instruction to provide two CQi values for the frequency allocation, one for the reliable or non-interfered radio resources and one for the unreliable or interfered radio resources, i.e. for the radio resources receiving additional unwanted emissions from the second frequency allocation FA2. These resources are the high order radio resources HORR. After having received the instruction the communication quality determining element 70 determines or provides one channel quality indication for each such block, step 104. The channel quality indications may be determined in a conventional way. Then the communication quality reporting element 72 reports the CQIs to the first base station, step 106.

It should here be realized that as an alternative it is possible that the communication quality determination instructing element 58 sends the interference profile to the communication quality determining element 70, which in turn itself determines that more than one CQI is to be determined based on the interference profile. Here it is also possible that the communication quality determining element 70 determines a difference in channel quality and reports to the first base station 13.

Therefore in this second embodiment of the method of assisting in communication improvement there may be
a CQI report scheme that indicates CQI for the reliable RBs and CQI for the unreliable RBs and possibly also
a delta value that indicates the expected difference in CQI between reliable and unreliable RBs

Now a third embodiment of the method of assisting in improving communication quality performed by a wireless communication device will be described with reference being made to FIG. 16. Also here the wireless communication device may be the first user device 24.

Also in this embodiment the communication quality determining element 70 uses the inference profile that was determined by the operation control device 48. The user device may do this based on receiving an instruction concerning the way communication quality indications (CQI) are to be provided. Such an instruction may be sent by the communication quality determination instructing element 58 of the operation control device 48 and received by the communication quality determining element 70, step 108. In this embodiment the instruction is an instruction to exclude the radio resources that are found to be unreliable or interfered from the determination of a CQI value for the frequency allocation. After having received the instruction the communication quality determining element 70 excludes interfered radio resources from the CQI determination, step 110. It thus determines a channel quality indication CQI for the first frequency allocation FA1 only based on non-interfered or reliable radio resources, and then the channel quality reporting element 72 reports the CQI to the first base station 13, step 112.

It should be realized that as an alternative it is also here possible that the communication quality determination instructing element 58 sends the interference profile to the communication quality determining element 70, which in turn itself determines that radio resources should be excluded from the CQI determination.

There is thus an adjustment to the CQI report such that it does not take into account RBs labelled as having poor reliability.

The invention can be modified in a number of ways in addition to those already described. It is for instance possible to combine any of the embodiments of the method of improving communication quality with any of the embodiments of the method of assisting in improving communication quality. It is also possible that communication quality is only improved in one frequency allocation, but not the other. Moreover, SINR is only one example of a communication quality measure being used. It is possible with also other measures, such as Bit Error Rate (BER)

The computer program code of the operation control device may be in the form of computer program product for instance in the form of a data carrier, such as a CD ROM disc or a memory stick. In this case the data carrier carries a computer program with the computer program code, which will implement the functionality of the above-described operation control device. One such data carrier 114 with computer program code 116 is schematically shown in FIG. 16.

The computer program code of the wireless communication device that has the function of assisting in improving communication quality may also be in the form of computer program product for instance in the form of a data carrier, such as a CD ROM disc or a memory stick. In this case the data carrier carries a computer program with the computer program code, which will implement this functionality of the above-described wireless communication device. One such data carrier 118 with computer program code 120 is schematically shown in FIG. 17.

The operation control device can as an alternative be considered as having means for determining a profile of the interference between transmissions in the two frequency allocations, the interference profile setting out radio resources in at least the first frequency allocation deemed to be interfered by transmissions in the second frequency allocation, and means for providing the interference profile for adjusting communication between the wireless communication node and the wireless communication devices for improving communication quality in the first frequency allocation, where the means for determining a profile of the interference corresponds to the interference profile determining unit and the means for providing the interference profile for adjusting communication corresponds to the interference profile providing unit.

The means for providing the interference profile for adjusting communication may furthermore comprise means for instructing wireless communication devices communicating in the first frequency allocation to adjust channel quality determinations based on the interference profile. The means for instructing wireless communication devices corresponds to the communication quality determination instructing element. The means for instructing wireless communication devices may more particularly be means for instructing wireless communication devices to provide two channel quality indications, one for interfered radio resources and one for non-interfered radio resources.

The means for instructing wireless communication devices may also be means for instructing the wireless communication devices to exclude the interfered radio resources from the determining of channel quality indications.

The means for instructing wireless communication devices may also comprise means for instructing the wireless communication devices to determine a difference in quality between the interfered radio resources and the non-interfered radio resources.

The means for providing the interference profile for adjusting communication may furthermore comprise means for using the interference profile to adjust operation in the first frequency allocation.

Moreover, the means for providing the interference profile for adjusting communication may comprise means for scheduling, in the first frequency allocation, wireless communication devices experiencing communication quality below a first communication quality threshold on radio resources experiencing interference and means for scheduling wireless communication devices experiencing communication quality above the first communication quality threshold on non-interfered radio resources. Alternatively, the means for providing the interference profile for adjusting communication may comprise means for scheduling wireless communication devices experiencing communication quality above a second communication quality threshold on the interfered radio resources. The means for scheduling in this case corresponds to the scheduling element.

The means for providing the interference profile for adjusting communication may furthermore comprise means for increasing, in the first frequency allocation, the robustness of the communication on the interfered radio resources. The means for improving robustness may in this case also comprise means for changing the coding and modulation. The means for increasing robustness corresponds to the robustness improving element.

In a similar manner, a wireless communication device may be considered as having means for adjusting communication settings for the first frequency allocation based on a profile of the interference between transmissions in the two frequency allocations. The means for adjusting communication settings in this case corresponds to the communication setting adjusting unit.

The means for adjusting communication settings may comprise means for adjusting channel quality determinations for the first frequency allocation. The means for adjusting channel quality determinations corresponds to the communication quality determining element.

The means for adjusting channel quality determinations may comprise means for performing two channel quality determinations, one for the non-interfered radio resources and another for the interfered radio resources. As an alternative it may comprise means for excluding the interfered radio resources from the determining of channel quality indications. Additionally it may comprise means for determining a difference in quality between the interfered radio resources and the non-interfered radio resources.

The means for adjusting communication settings may furthermore comprise means for reporting the channel quality determinations to the wireless communication node. The means for reporting channel quality determinations corresponds to the communication quality reporting element.

The wireless communication device may also comprise means for communicating on radio resources experiencing interference in case an own communication quality is below a first communication quality threshold and otherwise on non-interfered radio resources. It may furthermore comprise means for increasing the robustness of the communication in case it is carried out on radio resources experiencing interference, where the means for increasing robustness may comprise means for achieving increased robustness through a change in coding and modulation. The means for achieving increased robustness through a change in coding and modulation may comprise means for making a change in coding and modulation based on information about a coding and modulation difference received from the wireless communication network.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. A method of improving communication quality between a wireless communication node in a wireless communication network and at least two wireless communication devices, the wireless communication node operating using radio resources in a first frequency allocation with a first type of communication configuration and in a second frequency allocation with a second type of communication configuration, the method being performed by an operation control device controlling the operation of the wireless communication node and comprising:
determining a profile of the interference between transmissions in the two frequency allocations, the interference profile setting out radio resources in at least the first frequency allocation deemed to be interfered by transmissions in the second frequency allocation; and
providing the interference profile for adjusting communication between the wireless communication node and the wireless communication devices for improving communication quality in the first frequency allocation.

2. The method according to claim 1, wherein the providing of the interference profile for adjusting communication comprises instructing wireless communication devices communicating in the first frequency allocation to adjust channel quality determinations based on the interference profile.

3. The method according to claim 2, wherein the applying of the interference profile comprises informing of the radio resources deemed to be interfered.

4. The method according to claim 2, wherein the instruction is an instruction to provide two channel quality indications, one for interfered radio resources and one for non-interfered radio resources.

5. The method according to claim 1, wherein the instruction is an instruction to exclude the interfered radio resources from the determining of channel quality indications.

6.-11. (canceled)

12. An operation control device for improving communication quality between a wireless communication node in a wireless communication network and at least two wireless communication devices, the wireless communication node operating using radio resources in a first frequency allocation with a first type of communication configuration and in a second frequency allocation with a second type of communication configuration, the operation control device controlling the operation of the wireless communication node and comprising a processor and a memory, the memory containing instructions executable by the processor, the operation control device being configured to:
determine a profile of the interference between transmissions in the two frequency allocations, the interference profile setting out radio resources in at least the first frequency allocation deemed to be interfered by transmissions in the second frequency allocation; and
provide the interference profile for adjusting communication between the wireless communication node and the wireless communication devices for improving communication quality in the first frequency allocation.

13. The operation control device according to claim 12, which when providing the interference profile is configured to instruct wireless communication devices communicating in the first frequency allocation to adjust channel quality determinations based on the interference profile.

14. The operation control device according to claim 12, which when instructing wireless communication devices is configured to instruct these to provide two channel quality indications, one for interfered radio resources and one for non-interfered radio resources.

15. The operation control device according to claim 13, which when instructing wireless communication devices is configured to instruct the wireless communication devices to exclude the interfered radio resources from the determining of channel quality indications.

16. The operation control device according to claim 13, which when instructing wireless communication devices is configured to instruct the wireless communication devices to determine a difference in quality between the interfered radio resources and the non-interfered radio resources.

17.-23. (canceled)

24. A method of assisting in improving communication quality between a wireless communication node of a wireless communication network and at least two wireless communication devices, the wireless communication node operating using radio resources in a first frequency allocation with a first type of communication configuration and in a second frequency allocation with a second type of communication configuration, the method being performed by a wireless communication device communicating with the wireless communication node in the first frequency allocation and comprising:
adjusting communication settings for the first frequency allocation based on a profile of the interference between transmissions in the two frequency allocations, the interference profile setting out radio resources in at least the first frequency allocation deemed to be interfered by transmissions in the second frequency allocation.

25. The method according to claim 24, wherein the adjusting of communication settings comprises adjusting channel quality determinations for the first frequency allocation.

26. The method according to claim 25, wherein the adjusting of channel quality determinations comprises performing two channel quality determinations, one for the non-interfered radio resources and another for the interfered radio resources.

27. The method according to claim 25, wherein the adjusting of channel quality determinations comprises excluding the interfered radio resources from the determining of channel quality indications.

28. The method according to claim 26, wherein the adjusting of channel quality determinations comprises determining a difference in quality between the interfered radio resources and the non-interfered radio resources.

29.-34. (canceled)

35. A wireless communication device for assisting in improving communication quality between a wireless communication node of a wireless communication network and at least two wireless communication devices, the wireless communication node operating using radio resources in a first frequency allocation with a first type of communication configuration and in a second frequency allocation with a second type of communication configuration, the wireless communication device communicating with the wireless communication node in the first frequency allocation and comprising a processor and a memory, the memory containing instructions executable by the processor, the wireless communication device being configured to:
adjust communication settings for the first frequency allocation based on a profile of the interference between transmissions in the two frequency allocations, the interference profile setting out radio resources in at least the first frequency allocation deemed to be interfered by transmissions in the second frequency allocation.

36. The wireless communication device according to claim 35, which when adjusting communication settings is configured to adjust channel quality determinations for the first frequency allocation.

37. The wireless communication device according to claim 36, which when adjusting channel quality determinations is configured to perform two channel quality determinations, one for the non-interfered radio resources and another for the interfered radio resources.

38. The wireless communication device according to claim 36, which when adjusting channel quality determinations is configured to exclude the interfered radio resources from the determining of channel quality indications.

39. The wireless communication device according to claim 37, which when adjusting channel quality determinations is configured to determine a difference in quality between the interfered radio resources and the non-interfered radio resources.

40.-46. (canceled)
